(19) United States
(12) Patent Application Publication
(10) Pub. No.: US 2024/0414471 A1
(43) Pub. Date: Dec. 12, 2024

(54) SOUND PRESSURE CONTROL DEVICE, ELECTRONIC DEVICE, AND COMPONENT

(71) Applicant: SONY GROUP CORPORATION, TOKYO (JP)

(72) Inventors: ATSUSHI YAMAMOTO, TOKYO (JP); MASAKI KAMATA, TOKYO (JP); NAOKI SHINMEN, TOKYO (JP); YUTA SATO, TOKYO (JP)

(21) Appl. No.: 18/697,485

(22) PCT Filed: Aug. 19, 2022
(86) PCT No.: PCT/JP2022/031335

§ 371 Date: Apr. 1, 2024

(30) Foreign Application Priority Data
Oct. 11, 2021 (JP) 2021-166631

(51) Int. Cl. H04R 1/28; H04R 29/00

(52) U.S. Cl. CPC H04R 1/2873; H04R 29/001

(57) ABSTRACT

To contribute to downsizing of a device while reducing sound pressure of noise over a wide band. The present technology provides a sound pressure control device that includes a sound pressure control unit that includes a first path and a second path through which infiltrating sound passes, in which the first path is formed in a cylindrical shape in a direction differing from a direction in which the sound infiltrates, and the second path is formed in a spiral shape around an outer periphery of the first path. Furthermore, the present technology provides an electronic device and a component including the sound pressure control device.

### TECHNICAL FIELD

The present technology relates to a sound pressure control device, an electronic device, and a component.

### BACKGROUND ART

Conventionally, for example, in devices such as audio devices (such as headphones, earphones, or speakers) and telephones, there has been a demand for technology for reducing noise infiltrating from outside the device so that sound generated by the device can be clearly heard.

For example, Patent Document 1 discloses “A subwoofer including a plurality of protrusions arranged in a staggered manner so as to reduce a sound pressure level in a frequency band differing from a frequency band of a sound generated in a sound output unit, among frequency bands of sound that has infiltrated a housing through an opening.”

For example, Patent Document 2 discloses “a vehicle wheel capable of reducing noise due to air column resonance.”

### CITATION LIST

### Patent Document

Patent Document 1: Japanese Patent Application Laid-Open No. 2020-142552
Patent Document 2: Japanese Patent Application Laid-Open No. 2019-217979

### SUMMARY OF THE INVENTION

### Problems to be Solved by the Invention

In recent years, research on acoustic metamaterials that reduce sound pressure in audio devices has been attracting attention. For example, acoustic metamaterials using Helmholtz resonance and coil cavity are being used.

However, Helmholtz resonance is a phenomenon that occurs depending on resonance frequency. Therefore, in order to reduce the sound pressure over a wide band, a structure for controlling peaks and dips in resonance is necessary. A problem arises in that the device becomes large.

Furthermore, regarding coil cavity as well, in order to reduce the sound pressure over a wide band, arranging structures suitable for a plurality of different wavelengths side by side or arranging a plurality of coils of lengths corresponding to the wavelengths is necessary. Therefore, a problem arises in that the device becomes large.

Therefore, a main object of the present technology is to provide a sound pressure control device, an electronic device, and a component that contribute to downsizing of a device while reducing sound pressure of noise over a wide band.

### Solutions to Problems

The present technology provides a sound pressure control device that includes a sound pressure control unit that includes a first path and a second path through which infiltrating sound passes, in which the first path is formed in a cylindrical shape in a direction differing from a direction in which the sound infiltrates, and the second path is formed in a spiral shape around an outer periphery of the first path.

A traveling direction of sound passing through the first path may be a direction substantially perpendicular to the direction in which the sound infiltrates.

A plurality of second paths may be included.

The sound pressure control unit may have elasticity.

The first path may be formed in a circular cylindrical shape.

The first path may be formed in a rectangular cylindrical shape.

The first path may be formed in a spiral shape.

The sound pressure control device may further include an infiltrating portion that prompts infiltration of sound.

The infiltrating portion may be disposed near openings of the first path and the second path.

The sound pressure control device may further include a plurality of the infiltrating portions.

A length of the sound pressure control unit in the direction perpendicular to the direction in which sound passes through the first path may be 185 mm or less.

A length of the sound pressure control unit in the direction in which sound passes through the first path may be 220 mm or less.

The sound pressure control device may further include a shape control unit that changes a shape of the sound pressure control unit on the basis of infiltrating sound.

The shape control unit may include a magnet and a coil.

The sound pressure control device may further include a detecting unit that detects sound pressure of infiltrating sound.

In addition, the present technology provides an electronic device including the sound pressure control device.

Furthermore, the present technology provides a component including the sound pressure control device.

According to the present technology, a sound pressure control device, an electronic device, and a component that contribute to downsizing of a device while reducing sound pressure of noise over a wide band can be provided. Note that the effects described herein are not necessarily restrictive, and any of the effects described in the present disclosure may be exhibited.

### BRIEF DESCRIPTION OF DRAWINGS

FIG. 1 is a cross-sectional perspective view illustrating a configuration of a sound pressure control device 10 according to an embodiment of the present technology.

FIG. 2 is a simplified cross-sectional view illustrating a configuration example of the sound pressure control device 10 according to the embodiment of the present technology.

FIG. 3 is a graph illustrating simulation results of the sound pressure control device 10 according to the embodiment of the present technology.

FIG. 4 is a graph illustrating simulation results of the sound pressure control device 10 according to an embodiment of the present technology.

FIG. 5 is a perspective view illustrating a configuration of a sound pressure control unit 1 according to an embodiment of the present technology.

FIG. 6 is a perspective view illustrating a configuration of the sound pressure control unit 1 according to an embodiment of the present technology.

FIG. 7 is a cross-sectional perspective view illustrating a configuration of the sound pressure control device 10 according to an embodiment of the present technology.

FIG. 8 is a simplified cross-sectional view illustrating a configuration example of the sound pressure control device 10 according to the embodiment of the present technology.

FIG. 9 is a cross-sectional perspective view illustrating a configuration of the sound pressure control device 10 according to an embodiment of the present technology.

FIG. 10 is a block diagram illustrating a configuration example of the sound pressure control device 10 according to an embodiment of the present technology.

FIG. 11 is a cross-sectional perspective view illustrating a configuration example of the sound pressure control device 10 according to the embodiment of the present technology.

FIG. 12 is a cross-sectional perspective view illustrating a configuration example of an electronic device 7 according to an embodiment of the present technology.

FIG. 13 is a perspective view illustrating a configuration example of a component 8 according to an embodiment of the present technology.

FIG. 14 is a simplified diagram illustrating infiltration of noise from outside headphones.

FIG. 15 is a schematic perspective view illustrating an aspect of a simulation of the sound pressure control unit 1 according to an embodiment of the present technology.

FIG. 16 is a graph illustrating simulation results of the sound pressure control unit 1 according to the embodiment of the present technology.

### MODE FOR CARRYING OUT THE INVENTION

Hereinafter, preferred embodiments for carrying out the present invention will be described with reference to the drawings. Note that the embodiments described below illustrate examples of representative embodiments of the present invention, and the scope of the present invention is not limited by these examples. Furthermore, the present invention can combine any of the following examples and modifications thereof.

In the following description of the embodiments, the configuration may be described using terms with “substantially” such as substantially parallel and substantially orthogonal. For example, “substantially parallel” means not only being completely parallel, but also includes being substantially parallel, that is, a state shifted by, for example, about several percent from the completely parallel state. This similarly applies to other terms with “substantially”. Furthermore, each drawing is a schematic view and is not necessarily strictly illustrated.

In the drawings, unless otherwise specified, “upper” means upward or an upper side in the drawings, “lower” means downward or a lower side in the drawings, “left” means leftward or a left side in the drawings, and “right” means rightward or a right side in the drawings. In addition, in the drawings, the same or equivalent elements or members are denoted by the same reference signs, and redundant description will be omitted.

The description is given in the following order.
1. Overview of Present Technology
2. First Embodiment (Example 1 of Sound Pressure Control Device)
3. Second Embodiment (Example 2 of Sound Pressure Control Device)
4. Third Embodiment (Example 3 of Sound Pressure Control Device)
5. Fourth Embodiment (Example 4 of Sound Pressure Control Device)
6. Fifth Embodiment (Example 5 of Sound Pressure Control Device)
7. Sixth Embodiment (Example 6 of Sound Pressure Control Device)
8. Seventh Embodiment (Example 7 of Sound Pressure Control Device)
9. Eighth Embodiment (Example of Electronic Device)
10. Ninth Embodiment (Example of Component)

### 1. Overview of Present Technology

Conventionally, in devices such as audio devices and telephones described above, noise may infiltrate from outside the device. This point will be described with reference to FIG. 14. FIG. 14 is a simplified diagram illustrating infiltration of noise from outside headphones that are an example of the device. As illustrated in FIG. 14, a headphone main body 61 has a microphone 611, a noise canceling unit 612, and a driver 613. Noise N1 acquired by the microphone 611 is canceled by a waveform opposite to the noise N1 generated by the noise canceling unit 612. As a result, sound pressure of the noise N1 is reduced. Consequently, an effect in which signals such as reproduced music are transmitted to an eardrum E1 through the driver 613 and clearly heard occurs.

Meanwhile, there is also noise N2 that is not acquired by the microphone 611 and is inserted through, for example, a temple of eyeglasses or a gap between hairs. A technology for reducing the noise N2 is desired.

As described above, in recent years, research on acoustic metamaterials that reduce sound pressure in audio devices has been attracting attention. In particular, the following Non-Patent Document describes that sound pressure can be reduced by Fano effect known in the field of quantum mechanics being applied to sound.

### Non-Patent Document

R. Ghaffarivardavagh et al., “Ultra-open acoustic metamaterial silencer based on Fano-like interference”, Physical Review B, 2019, Vol. 99

When this technology is used and the acoustic metamaterial capable of reducing the sound pressure of noise is mounted in headphones, for example, the size of the acoustic metamaterial is several tens of centimeters in order to reduce the sound pressure. Consequently, a problem arises in that the headphones become large.

Therefore, a main object of the present technology is to provide a sound pressure control device (acoustic metamaterial) that contributes to downsizing of a device while reducing sound pressure over a wide band through contrivance of the configuration.

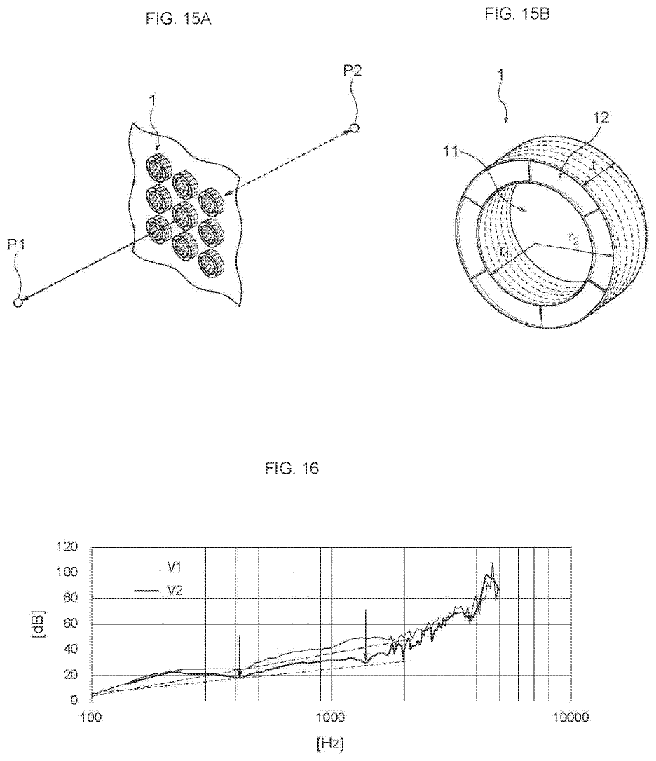

Here, a simulation of a sound pressure reduction effect of a sound pressure control device according to an embodiment of the present technology will be described with reference to FIG. 15.

FIG. 15 is a schematic perspective view illustrating an aspect of a simulation of a sound pressure control unit 1 according to an embodiment of the present technology. As illustrated in FIG. 15A, a plurality of sound pressure control units 1 is arranged side by side on a wall.

FIG. 15B is an enlarged view of the sound pressure control unit 1. As illustrated in FIG. 15B, each sound pressure control unit 1 includes a first path 11 and a second path 12 through which sound passes. The first path 11 is formed in a cylindrical shape and the second path 12 is formed in a spiral shape around an outer periphery of the first path 11.

Specifications of each sound pressure control unit 1 are that a ratio of an inner diameter r₁ (diameter of the first path 11), an outer diameter r₂, and a length t in a traveling direction of sound is 4:5:5, and an inclination angle of the second path 12 formed in a spiral shape is 4 degrees.

In the simulation, the sound pressure of sound emitted at point P1 is measured at point P2. Point P1 and point P2 are both one meter away from the sound pressure control unit 1.

The simulation was conducted in each of a case where the sound pressure control units 1 are not arranged and a case where the sound pressure control units 1 are arranged. FIG. 16 is a graph illustrating simulation results of the sound pressure control unit 1 according to the embodiment of the present technology. In FIG. 16, a horizontal axis indicates frequency and a vertical axis indicates measured sound pressure. A value V1 in a case where the sound pressure control units 1 are not arranged and a value V2 in a case where the sound pressure control units 1 are arranged are illustrated. As illustrated in FIG. 16, compared to a case where the sound pressure control units 1 are not arranged, the sound pressure is reduced over a wide band in a case where the sound pressure control units 1 are arranged. This is dependent on a ratio between acoustic impedance in the first path 11 and acoustic impedance in the second path.

In addition, as indicated by a downward arrow, the sound pressure is particularly reduced at a specific frequency. This is dependent on the inner diameter r₁, the outer diameter r₂, the length t in the traveling direction of sound, the inclination angle, and the like of the sound pressure control unit 1. As a result of the inner diameter r₁, the outer diameter r₂, the length t in the traveling direction of sound, the inclination angle, and the like of the sound pressure control unit 1 being adjusted, the sound pressure at a desired frequency can be reduced.

### 2. First Embodiment (Example 1 of Sound Pressure Control Device)

The present technology provides a sound pressure control device that includes a sound pressure control unit that includes a first path and a second path through which infiltrating sound passes, in which the first path is formed in a cylindrical shape in a direction differing from a direction in which the sound infiltrates, and the second path is formed in a spiral shape around an outer periphery of the first path.

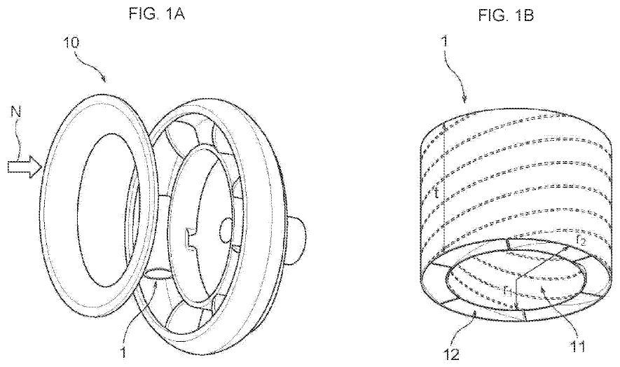

An embodiment of the present technology will be described with reference to FIG. 1. FIG. 1 is a cross-sectional perspective view illustrating a configuration of a sound pressure control device 10 according to an embodiment of the present technology. As illustrated in FIG. 1A, the sound pressure control device 10 according to the embodiment of the present technology is provided in an ear pad 62 for headphones that are an example of an audio device.

When a user is wearing the ear pad 62, sound N infiltrates the ear pad 62 in a direction of an arrow through a temple of eyeglasses, hair, or the like.

The sound pressure control device 10 according to the embodiment of the present technology includes the sound pressure control unit 1. FIG. 1B is an enlarged view of the sound pressure control unit 1. As illustrated in FIG. 1B, the sound pressure control unit 1 includes the first path 11 and the second path 12 through which the infiltrating sound N passes. The second path 12 is formed in a spiral shape around the outer periphery of the first path 11. As a result of the acoustic impedance in the first path 11 and the acoustic impedance in the second path 12 differing, sound pressure of the infiltrating sound N is reduced as described in the above-described Non-Patent Document. The first path 11 and the second path 12 are each preferably formed to be long.

The first path 11 is formed in a cylindrical shape in a direction differing from a direction in which the sound N infiltrates. That is, the sound pressure control unit 1 is formed in a cylindrical shape in a direction differing from the direction in which the sound N infiltrates. As a result, even when the first path 11 and the second path 12 each become long, thickness of the ear pad 62 becomes small. Consequently, the present technology can contribute to downsizing of the headphones.

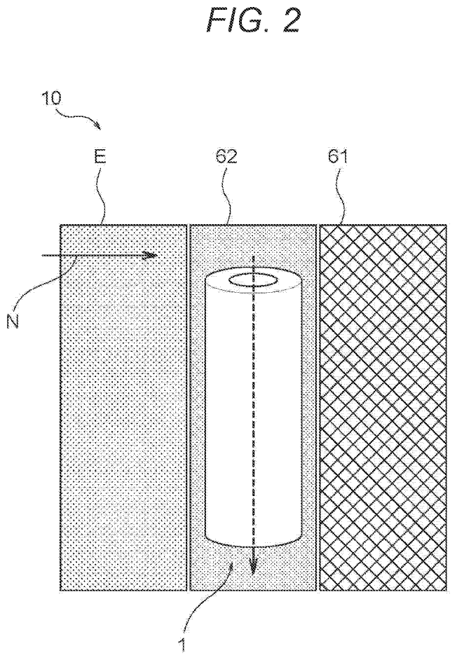

The traveling direction of sound passing through the first path 11 is not particularly limited as long as the traveling direction differs from the direction in which the sound N infiltrates. However, the traveling direction is preferably a direction substantially perpendicular to the direction in which the sound N infiltrates. This point will be described with reference to FIG. 2. FIG. 2 is a schematic cross-sectional view illustrating a configuration example of the sound pressure control device 10 according to the embodiment of the present technology. In FIG. 2, an ear E, the ear pad 62, and the headphone main body 61 are illustrated. As illustrated in FIG. 2, the sound pressure control unit 1 is arranged in the direction substantially perpendicular to the direction in which the sound N infiltrates. As a result, the thickness of the ear pad 62 is further reduced and the headphones are further downsized.

The first path 11 is formed in a circular cylindrical shape. A shape in a cross-sectional view in the direction perpendicular to the traveling direction of sound may be a perfect circle or an ellipse.

The sound pressure control unit 1 may include a plurality of second paths 12. As a result, the sound pressure of noise is further reduced. The number of second paths 12 is not particularly limited but, for example, may be about six. The sound pressure of noise is further reduced as the number of second paths 12 increases. However, the inclination angle of the second path 12 decreases. Therefore, the number of second paths 12 is preferably designed appropriately.

As a result of the sound pressure control device 10 being provided in the ear pad 62, the sound pressure of noise infiltrating from gaps is reduced. Ordinarily, when an audio device such as headphones is designed, the audio device is generally designed to have high sealability to prevent infiltration of noise. However, in this case, pressure is applied to the head of the user and the user experiences discomfort. As a result of the present technology, the sound pressure of noise infiltrating from gaps is reduced. Therefore, it is acceptable for gaps to be present. Consequently, the user can comfortably wear the audio device.

Note that, according to the present embodiment, the sound pressure control device 10 is provided in the ear pad 62 for headphones as an example, but is not limited thereto. For example, the sound pressure control device 10 according to the embodiment of the present technology can be provided in an earpiece for an earphone, a frame for a speaker, or the like. Alternatively, the sound pressure control device 10 can also be provided in a speaker for a telephone or the like.

Here, a simulation of the sound pressure reduction effect of the sound pressure control device 10 in an aspect illustrated in FIG. 2 will be described.

Specifications of the sound pressure control unit 1 are that the ratio of the inner diameter r₁ (diameter of the first path 11), the outer diameter r₂, and the length t in the traveling direction of sound is 4:5:5, and the inclination angle of the second path 12 formed in a spiral shape is 4 degrees.

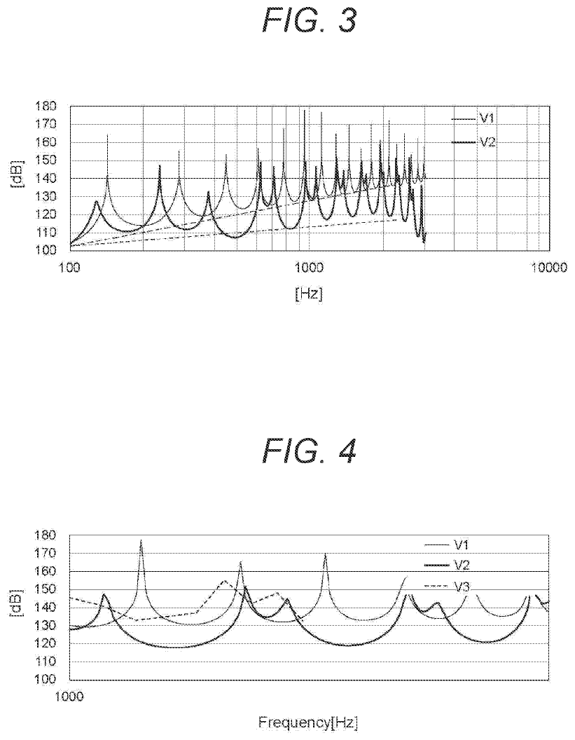

The simulation was conducted in each of the case where the sound pressure control units 1 are not arranged and the case where the sound pressure control units 1 are arranged. Results of the simulations will be described with reference to FIG. 3. FIG. 3 is a graph illustrating the simulation results of the sound pressure control device 10 according to the embodiment of the present technology. In FIG. 3, the horizontal axis indicates frequency and the vertical axis indicates measured sound pressure. The value V1 in a case where the sound pressure control units 1 are not arranged and the value V2 in a case where the sound pressure control units 1 are arranged are illustrated. As illustrated in FIG. 3, compared to a case where the sound pressure control units 1 are not arranged, the sound pressure is reduced over a wide band in a case where the sound pressure control units 1 are arranged. Note that the reason a position of a peak in a case where the sound pressure control units 1 are arranged is shifted to the left or right compared to a case where the sound pressure control units 1 are not arranged is because of an effect of the second path 12 being formed in the spiral shape.

The size of the sound pressure control unit 1 is not particularly limited. However, a length (outer diameter r₂) in a direction perpendicular to a direction in which sound passes through the first path 11 is preferably 225 mm or less. The length re is more preferably 205 mm or less and still more preferably 185 mm or less.

In addition, the length t in the direction in which sound passes through the first path 11 is preferably 260 mm or less. The length t is more preferably 240 mm or less and still more preferably 220 mm or less.

As a result of the size of the sound pressure control unit 1 being the above-described values, the sound pressure control device 10 can be built in various devices.

The above content described for the sound pressure control device according to the first embodiment of the present technology can be applied to other embodiments of the present technology as long as there is no technical contradiction.

### 3. Second Embodiment (Example 2 of Sound Pressure Control Device)

As a result of the sound pressure control device 10 according to an embodiment of the present technology having a configuration such as that described above, the sound pressure control unit 1 can have elasticity. As a result, when the sound pressure control device 10 is provided in an ear pad or the like, the sound pressure control unit 1 can follow deformation caused by wearing of the headphones. Consequently, wearability is improved.

An effect of reducing sound pressure when the first path 11 and/or the second path 12 is elastically deformed will be described with reference to FIG. 4. FIG. 4 is a graph illustrating simulation results of the sound pressure control device 10 according to the embodiment of the present technology. In FIG. 4, the horizontal axis indicates frequency and the vertical axis indicates measured sound pressure. The value V1 in a case where the sound pressure control units 1 are not arranged, the value V2 in a case where the sound pressure control units 1 are arranged, and a value V3 in a case where the sound pressure control unit 1 is elastically deformed are illustrated. Regarding this elastic deformation, a perfect circle was deformed into an elliptical having an aspect ratio of 4:6 in a cross-sectional view in the direction perpendicular to the traveling direction of sound. As illustrated in FIG. 4, the sound pressure is reduced over a wide band even in a case where the sound pressure control unit 1 is elastically deformed. The sound pressure control unit 1 can reduce the sound pressure over a wide band even should the inner diameter and the outer diameter change by about 20% in the cross-sectional view in the direction perpendicular to the traveling direction of sound.

A material of the sound pressure control unit 1 is not particularly limited. However, for example, an elastomer resin can be used.

The above content described for the sound pressure control device according to the second embodiment of the present technology can be applied to other embodiments of the present technology as long as there is no technical contradiction.

### 4. Third Embodiment (Example 3 of Sound Pressure Control Device)

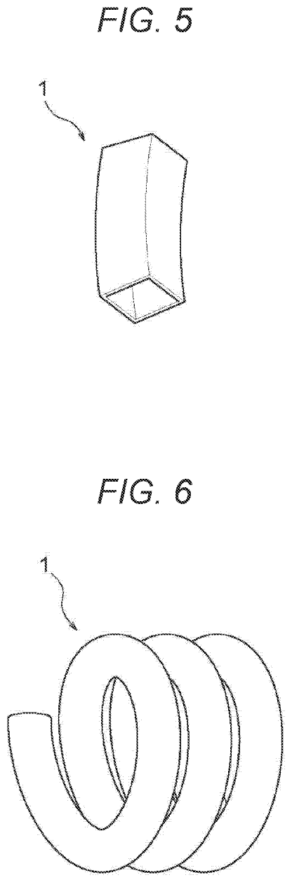

In the sound pressure control unit 1 according to an embodiment of the present technology, the first path 11 may be formed in a rectangular cylindrical shape. This point will be described with reference to FIG. 5. FIG. 5 is a perspective view illustrating a configuration of the sound pressure control unit 1 according to the embodiment of the present technology. As illustrated in FIG. 5, the first path 11 is formed in a rectangular cylindrical shape. As a result, the sound pressure control unit 1 can match a prismatic groove. Consequently, the sound pressure of noise is further reduced.

A cross-sectional shape of the sound pressure control unit 1 may be a rectangle such as that illustrated in FIG. 5 in the cross-sectional view in the direction perpendicular to the traveling direction of sound. For example, the rectangle includes a square, a rectangle, a square with rounded corners, and a rectangle with rounded corners. Furthermore, the cross-sectional shape may be a polygon such as a triangle, a pentagon, or a hexagon.

The above content described for the sound pressure control device according to the third embodiment of the present technology can be applied to other embodiments of the present technology as long as there is no technical contradiction.

### 5. Fourth Embodiment (Example 4 of Sound Pressure Control Device)

In the sound pressure control unit 1 according to an embodiment of the present technology, the first path 11 may be formed in a spiral shape. This point will be described with reference to FIG. 6. FIG. 6 is a perspective view illustrating a configuration of the sound pressure control unit 1 according to the embodiment of the present technology. As illustrated in FIG. 6, the first path 11 is formed in a spiral shape. Although not illustrated, the second path is formed in a spiral shape around the outer periphery of the first path 11. That is, the sound pressure control unit 1 is formed in a spiral shape. As a result, even in a case where an arrangement space of the sound pressure control unit 1 is small, the ratio between the acoustic impedance in the first path 11 and the acoustic impedance in the second path 12 can be appropriately adjusted. Consequently, the sound pressure of noise is further reduced.

The above content described for the sound pressure control device according to the fourth embodiment of the present technology can be applied to other embodiments of the present technology as long as there is no technical contradiction.

### 6. Fifth Embodiment (Example 5 of Sound Pressure Control Device)

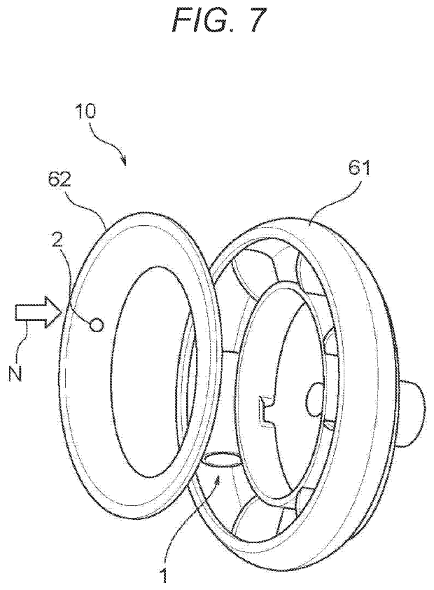

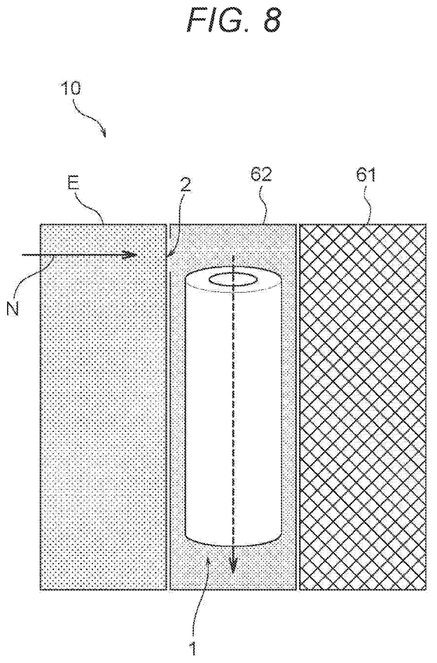

The sound pressure control device 10 according to an embodiment of the present technology may further include an infiltrating portion that prompts infiltration of sound. This point will be described with reference to FIG. 7 and FIG. 8. FIG. 7 is a cross-sectional perspective view illustrating a configuration of the sound pressure control device 10 according to the embodiment of the present technology. FIG. 8 is a simplified cross-sectional view illustrating a configuration example of the sound pressure control device 10 according to the embodiment of the present technology.

As illustrated in FIG. 7 and FIG. 8, the sound pressure control device 10 according to the embodiment of the present technology further includes an infiltrating portion 2 that prompts infiltration of sound. As a result, external noise N actively infiltrates the sound pressure control unit 1 through the infiltrating portion 2. Consequently, the sound pressure of noise N is further reduced. The infiltrating portion 2 is preferably disposed near the temple of eyeglasses, hair, or the like through which noise easily infiltrates.

The infiltrating portion 2 is preferably disposed near openings of the first path 11 and the second path 12. As a result, external noise N actively infiltrates the sound pressure control unit 1 through the infiltrating portion 2. Consequently, the sound pressure of noise N is further reduced.

The above content described for the sound pressure control device according to the fifth embodiment of the present technology can be applied to other embodiments of the present technology as long as there is no technical contradiction.

### 7. Sixth Embodiment (Example 6 of Sound Pressure Control Device)

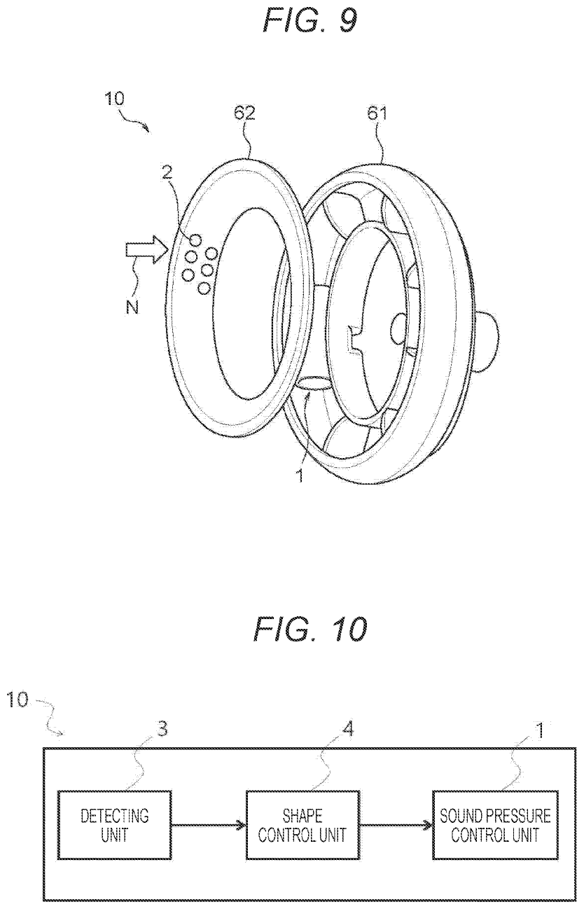

The sound pressure control device 10 according to an embodiment of the present technology may further include a plurality of infiltrating portions. This point will be described with reference to FIG. 9. FIG. 9 is a cross-sectional perspective view illustrating a configuration of the sound pressure control device 10 according to the embodiment of the present technology. As illustrated in FIG. 9, the sound pressure control device 10 according to the embodiment of the present technology includes a plurality of the infiltrating portions 2 that prompt infiltration of sound. As a result, external noise N more actively infiltrates the sound pressure control unit 1 through the infiltrating portions 2. Consequently, the sound pressure of noise N is further reduced.

In addition, infiltration of dust and the like can be prevented should the infiltrating portion 2 have a porous mesh shape.

The above content described for the sound pressure control device according to the sixth embodiment of the present technology can be applied to other embodiments of the present technology as long as there is no technical contradiction.

### 8. Seventh Embodiment (Example 7 of Sound Pressure Control Device)

The sound pressure control device 10 according to an embodiment of the present technology may further include a shape control unit that changes the shape of the sound pressure control unit on the basis of infiltrating sound. This point will be described with reference to FIG. 10. FIG. 10 is a block diagram illustrating a configuration example of the sound pressure control device 10 according to the embodiment of the present technology.

As illustrated in FIG. 10, the sound pressure control device 10 includes a detecting unit 3, a shape control unit 4, and the sound pressure control unit 1.

The detecting unit 3 can detect infiltrating sound. For example, the detecting unit 3 can be actualized through use of a microphone or the like.

The shape control unit 4 can change the shape of the sound pressure control unit 1 on the basis of the infiltrating sound detected by the detecting unit 3. As a result, the inner diameter and the outer diameter of the sound pressure control unit 1, the length of the sound pressure control unit 1 in the traveling direction of sound, the inclination angle of the second path 12, and the like change according to the sound pressure, the frequency, and the like of the infiltrating sound. Consequently, the sound pressure control unit 1 can reduce the sound pressure at a desired frequency.

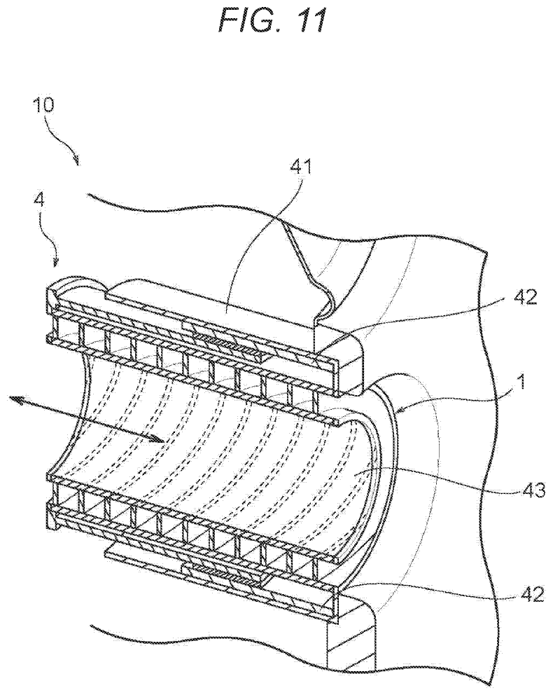

A configuration example in which the shape control unit 4 includes a magnet and a coil will be described with reference to FIG. 11 FIG. 11 is a cross-sectional perspective view illustrating a configuration example of the sound pressure control device 10 according to the embodiment of the present technology. As illustrated in FIG. 11, the shape control unit 4 includes a magnet 41, a coil 42, and a supporting portion 43.

The magnet 41 is disposed along a length direction of the sound pressure control unit 1 on the outer periphery of the sound pressure control unit 1. The coil 42 is disposed along the length direction of the sound pressure control unit 1 between the magnet 41 and the sound pressure control unit 1. The supporting portion 43 is metal or the like that provides support so that the second path 12 is not deformed, and is disposed along inner walls and outer walls of the first path 11 and the second path 12.

Similarly to a voice coil motor, the shape control unit 4 has a function for converting electric energy into kinetic energy using a magnetic field as a medium. As a result of a current flowing through the coil 42, a force is generated in a direction of an arrow according to Fleming's left-hand rule. As a result, the sound pressure control unit 1 expands and contracts in the length direction. For example, the sound pressure control unit 1 may expand in a case where external wind is strong. The sound pressure control unit 1 may contract in a case where external noise is low.

Note that this is merely an example, and there may be other examples for changing the shape of the sound pressure control unit 1.

The above content described for the sound pressure control device according to the seventh embodiment of the present technology can be applied to other embodiments of the present technology as long as there is no technical contradiction.

### 9. Eighth Embodiment (Example of Electronic Device)

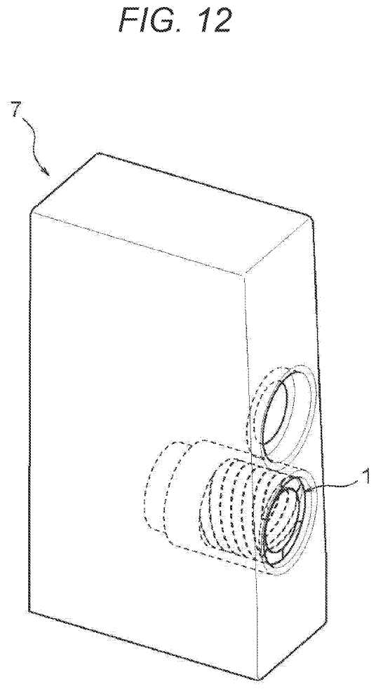

The sound pressure control device 10 according to an embodiment of the present technology can be provided in an electronic device. The electronic device includes audio devices such as earphones and a speaker illustrated in FIG. 12, as well as the above-described headphones. FIG. 12 is a cross-sectional perspective view illustrating a configuration example of an electronic device 7 according to the embodiment of the present technology. As illustrated in FIG. 12, the sound pressure control device 10 is provided in a speaker that is an example of the electronic device 7.

Furthermore, the electronic device 7 includes any device that guides generated sound to a user's ear, such as a telephone.

The above content described for the electronic device according to the eighth embodiment of the present technology can be applied to other embodiments of the present technology as long as there is no technical contradiction.

### 10. Ninth Embodiment (Example of Component)

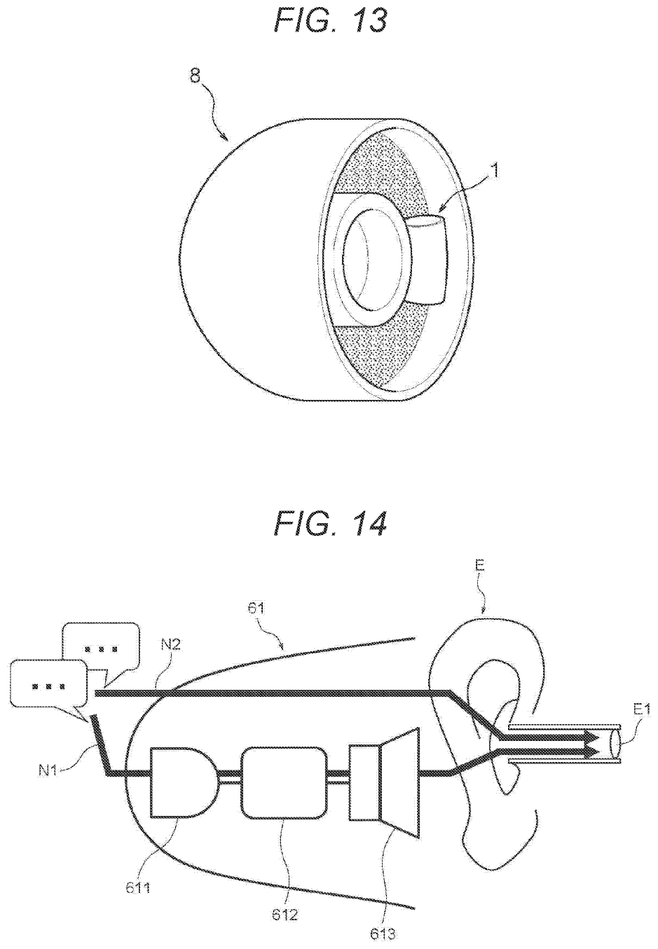

The sound pressure control device 10 according to an embodiment of the present technology can be provided in a component. The component may be included in the above-described electronic device. The component includes components such as a frame for a speaker and an earpiece for an earphone illustrated in FIG. 13, as well as the above-described ear pad. FIG. 13 is a perspective view illustrating a configuration example of a component 8 according to the embodiment of the present technology. As illustrated in FIG. 13, the sound pressure control device 10 is provided in an earpiece that is an example of the component 8.

The above content described for the component according to the ninth embodiment of the present technology can be applied to other embodiments of the present technology as long as there is no technical contradiction.

Note that the embodiments according to the present technology are not limited to the above-described embodiments, and various modifications can be made without departing from the gist of the present technology.

Furthermore, the present technology can also have the following configurations.

[1]

A sound pressure control device including
a sound pressure control unit including a first path and a second path through which infiltrating sound passes, in which
the first path is formed in a cylindrical shape in a direction differing from a direction in which the sound infiltrates, and
the second path is formed in a spiral shape around an outer periphery of the first path.
   [2]

The sound pressure control device according to [1], in which
a traveling direction of sound passing through the first path is a direction substantially perpendicular to the direction in which the sound infiltrates.
   [3]

The sound pressure control device according to [1] or [2], further including
a plurality of the second paths.
   [4]

The sound pressure control device according to any one of [1] to [3], in which
the sound pressure control unit has elasticity.
   [5]

The sound pressure control device according to any one of [1] to [4], in which
the first path is formed in a circular cylindrical shape.
   [6]

The sound pressure control device according to any one of [1] to [5], in which
the first path is formed in a rectangular cylindrical shape.
   [7]

The sound pressure control device according to any one of [1] to [6], in which
the first path is formed in a spiral shape.
   [8]

The sound pressure control device according to any one of [1] to [7], further including
an infiltrating portion that prompts infiltration of sound.
   [9]

The sound pressure control device according to [8], in which
the infiltrating portion is disposed near openings of the first path and the second path.
   [10]

The sound pressure control device according to [8] or [9], further including
a plurality of the infiltrating portions.
   [11]

The sound pressure control device according to any one of [1] to [10], in which
a length of the sound pressure control unit in a direction perpendicular to a direction in which sound passes through the first path is 185 mm or less.
   [12]

The sound pressure control device according to any one of [1] to [11], in which
a length of the sound pressure control unit in a direction in which sound passes through the first path is 220 mm or less.
   [13]

The sound pressure control device according to any one of [1] to [12], further including
a shape control unit that changes a shape of the sound pressure control unit on the basis of infiltrating sound.
   [14]

The sound pressure control device according to [13], in which
the shape control unit includes a magnet and a coil.
   [15]

The sound pressure control device according to any one of [1] to [14], further including
a detecting unit that detects sound pressure of infiltrating sound.
   [16]

An electronic device including the sound pressure control device according to any one of [1] to.

[17]

A component including the sound pressure control device according to any one of [1] to.

### REFERENCE SIGNS LIST

10 Sound pressure control device
1 Sound pressure control unit
11 First path
12 Second path
2 Infiltrating portion
3 Detecting unit
4 Shape control unit
41 Magnet
42 Coil
43 Supporting portion
61 Headphone main body
611 Microphone
612 Noise canceling unit
613 Driver
62 Ear pad
7 Speaker (electronic device)
8 Earpiece (component)

1. A sound pressure control device comprising:
a sound pressure control unit including a first path and a second path through which infiltrating sound passes, wherein
the first path is formed in a cylindrical shape in a direction differing from a direction in which the sound infiltrates, and
the second path is formed in a spiral shape around an outer periphery of the first path.

2. The sound pressure control device according to claim 1, wherein
a traveling direction of sound passing through the first path is a direction substantially perpendicular to the direction in which the sound infiltrates.

3. The sound pressure control device according to claim 1, further comprising:
a plurality of the second paths.

4. The sound pressure control device according to claim 1, wherein
the sound pressure control unit has elasticity.

5. The sound pressure control device according to claim 1, wherein
the first path is formed in a circular cylindrical shape.

6. The sound pressure control device according to claim 1, wherein
the first path is formed in a rectangular cylindrical shape.

7. The sound pressure control device according to claim 1, wherein
the first path is formed in a spiral shape.

8. The sound pressure control device according to claim 1, further comprising:
an infiltrating portion that prompts infiltration of sound.

9. The sound pressure control device according to claim 8, wherein
the infiltrating portion is disposed near openings of the first path and the second path.

10. The sound pressure control device according to claim 8, further comprising:
a plurality of the infiltrating portions.

11. The sound pressure control device according to claim 1, wherein
a length of the sound pressure control unit in a direction perpendicular to a direction in which sound passes through the first path is 185 mm or less.

12. The sound pressure control device according to claim 1, wherein
a length of the sound pressure control unit in a direction in which sound passes through the first path is 220 mm or less.

13. The sound pressure control device according to claim 1, further comprising:
a shape control unit that changes a shape of the sound pressure control unit on a basis of infiltrating sound.

14. The sound pressure control device according to claim 13, wherein
the shape control unit includes a magnet and a coil.

15. The sound pressure control device according to claim 1, further comprising:
a detecting unit that detects sound pressure of infiltrating sound.

16. An electronic device comprising the sound pressure control device according to claim 1.

17. A component comprising the sound pressure control device according to claim 1.
